(19) United States
(12) Patent Application Publication
(10) Pub. No.: US 2014/0229659 A1
(43) Pub. Date: Aug. 14, 2014

(54) THIN TRANSLATION FOR SYSTEM ACCESS OF NON VOLATILE SEMICONDCUTOR STORAGE AS RANDOM ACCESS MEMORY

(71) Applicant: Marc T. Jones, Longmont, CO (US)

(72) Inventor: Marc T. Jones, Longmont, CO (US)

(21) Appl. No.: 13/997,658

(22) PCT Filed: Dec. 30, 2011
(86) PCT No.: PCT/US2011/068195

§ 371 Date: Jun. 24, 2013

(51) Int. Cl. G06F 3/06

(52) U.S. Cl. CPC G06F 3/061; G06F 3/0688; G06F 3/0659
USPC 711/103

(57) ABSTRACT

A semiconductor chip is described having a controller having a point-to-point link interface and non volatile memory interfacing circuitry. The point-to-point link interface is to receive a command from a system that identifies a particular non volatile memory. The non volatile memory interfacing circuitry is to receive and forward the command to the non volatile random access memory.

### BACKGROUND

1. Field of the Invention

This invention relates generally to the field of computer systems. More particularly, the invention relates to an apparatus and method for implementing a multi-level memory hierarchy including a non-volatile memory tier.

2. Description of the Related Art

A. Current Memory and Storage Configurations

One of the limiting factors for computer innovation today is memory and storage technology. In conventional computer systems, system memory (also known as main memory, primary memory, executable memory) is typically implemented by dynamic random access memory (DRAM). DRAM-based memory consumes power even when no memory reads or writes occur because it must constantly recharge internal capacitors. DRAM-based memory is volatile, which means data stored in DRAM memory is lost once the power is removed. Conventional computer systems also rely on multiple levels of caching to improve performance. A cache is a high speed memory positioned between the processor and system memory to service memory access requests faster than they could be serviced from system memory. Such caches are typically implemented with static random access memory (SRAM). Cache management protocols may be used to ensure that the most frequently accessed data and instructions are stored within one of the levels of cache, thereby reducing the number of memory access transactions and improving performance.

With respect to mass storage (also known as secondary storage or disk storage), conventional mass storage devices typically include magnetic media (e.g., hard disk drives), optical media (e.g., compact disc (CD) drive, digital versatile disc (DVD), etc.), holographic media, and/or mass-storage flash memory (e.g., solid state drives (SSDs), removable flash drives, etc.). Generally, these storage devices are considered Input/Output (I/O) devices because they are accessed by the processor through various I/O adapters that implement various I/O protocols. These I/O adapters and I/O protocols consume a significant amount of power and can have a significant impact on the die area and the form factor of the platform. Portable or mobile devices (e.g., laptops, netbooks, tablet computers, personal digital assistant (PDAs), portable media players, portable gaming devices, digital cameras, mobile phones, smartphones, feature phones, etc.) that have limited battery life when not connected to a permanent power supply may include removable mass storage devices (e.g., Embedded Multimedia Card (eMMC), Secure Digital (SD) card) that are typically coupled to the processor via low-power interconnects and I/O controllers in order to meet active and idle power budgets.

With respect to firmware memory (such as boot memory (also known as BIOS flash)), a conventional computer system typically uses flash memory devices to store persistent system information that is read often but seldom (or never) written to. For example, the initial instructions executed by a processor to initialize key system components during a boot process (Basic Input and Output System (BIOS) images) are typically stored in a flash memory device. Flash memory devices that are currently available in the market generally have limited speed (e.g., 50 MHz). This speed is further reduced by the overhead for read protocols (e.g., 2.5 MHz). In order to speed up the BIOS execution speed, conventional processors generally cache a portion of BIOS code during the Pre-Extensible Firmware Interface (PEI) phase of the boot process. The size of the processor cache places a restriction on the size of the BIOS code used in the PEI phase (also known as the “PEI BIOS code”).

B. Phase-Change Memory (PCM) and Related Technologies

Phase-change memory (PCM), also sometimes referred to as phase change random access memory (PRAM or PCRAM), PCME, Ovonic Unified Memory, or Chalcogenide RAM (C-RAM), is a type of non-volatile computer memory which exploits the unique behavior of chalcogenide glass. As a result of heat produced by the passage of an electric current, chalcogenide glass can be switched between two states: crystalline and amorphous. Recent versions of PCM can achieve two additional distinct states.

PCM provides higher performance than flash because the memory element of PCM can be switched more quickly, writing (changing individual bits to either 1 or 0) can be done without the need to first erase an entire block of cells, and degradation from writes is slower (a PCM device may survive approximately 100 million write cycles; PCM degradation is due to thermal expansion during programming, metal (and other material) migration, and other mechanisms).

### BRIEF DESCRIPTION OF THE DRAWINGS

The following description and accompanying drawings are used to illustrate embodiments of the invention. In the drawings:

FIG. 1 illustrates a cache and system memory arrangement according to one embodiment of the invention;

FIG. 2 illustrates a memory and storage hierarchy employed in one embodiment of the invention;

FIG. 3 illustrates a computer system on which embodiments of the invention may be implemented;

FIG. 4 (prior art) shows a traditional SSD;

FIG. 5 illustrates a device having non volatile semiconductor storage devices capable of being accessed as random access memories by a system;

FIG. 6a illustrates a first arrangement of cards plugged into a backplane;

FIG. 6b illustrates a second arrangement of cards plugged into a backplane;

FIG. 7 illustrates a method capable of being performed by the controller of FIGS. 5, 6a and 6b;

FIG. 8 illustrates an embodiment of the controller of FIGS. 5, 6a and 6b;

### DETAILED DESCRIPTION

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Bracketed text and blocks with dashed borders (e.g., large dashes, small dashes, dot-dash, dots) are sometimes used herein to illustrate optional operations/components that add additional features to embodiments of the invention. However, such notation should not be taken to mean that these are the only options or optional operations/components, and/or that blocks with solid borders are not optional in certain embodiments of the invention.

### INTRODUCTION

Memory capacity and performance requirements continue to increase with an increasing number of processor cores and new usage models such as virtualization. In addition, memory power and cost have become a significant component of the overall power and cost, respectively, of electronic systems.

Some embodiments of the invention solve the above challenges by intelligently subdividing the performance requirement and the capacity requirement between memory technologies. The focus of this approach is on providing performance with a relatively small amount of a relatively higher-speed memory such as DRAM while implementing the bulk of the system memory using significantly cheaper and denser non-volatile random access memory (NVRAM). Embodiments of the invention described below define platform configurations that enable hierarchical memory subsystem organizations for the use of NVRAM. The use of NVRAM in the memory hierarchy also enables new usages such as expanded boot space and mass storage implementations, as described in detail below.

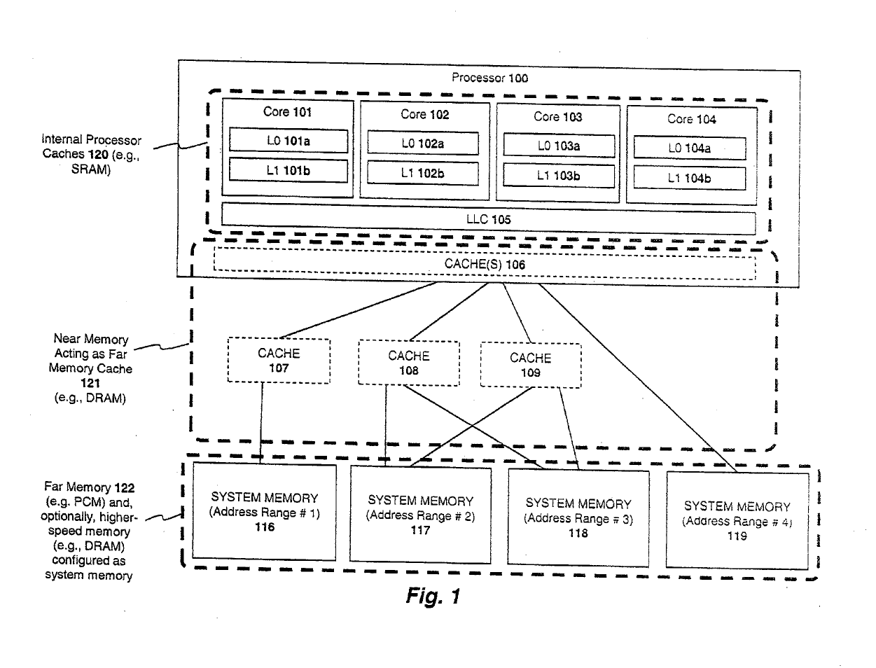

FIG. 1 illustrates a cache and system memory arrangement according to embodiments of the invention. Specifically, FIG. 1 shows a memory hierarchy including a set of internal processor caches 120, “near memory” acting as a far memory cache 121, which may include both internal cache(s) 106 and external caches 107-109, and “far memory” 122. One particular type of memory which may be used for “far memory” in some embodiments of the invention is non-volatile random access memory (“NVRAM”). As such, an overview of NVRAM is provided below, followed by an overview of far memory and near memory.

A. Non-Volatile Random Access Memory (“NVRAM”)

There are many possible technology choices for NVRAM, including PCM, Phase Change Memory and Switch (PCMS) (the latter being a more specific implementation of the former), byte-addressable persistent memory (BPRAM), storage class memory (SCM), universal memory, Ge2Sb2Te5, programmable metallization cell (PMC), resistive memory (RRAM), RESET (amorphous) cell, SET (crystalline) cell, PCME, Ovshinsky memory, ferroelectric memory (also known as polymer memory and poly(N-vinylcarbazole)), ferromagnetic memory (also known as Spintronics, SPRAM (spin-transfer torque RAM), STRAM (spin tunneling RAM), magnetoresistive memory, magnetic memory, magnetic random access memory (MRAM)), and Semiconductor-oxide-nitride-oxide-semiconductor (SONOS, also known as dielectric memory).

NVRAM has the following characteristics:

(1) It maintains its content even if power is removed, similar to FLASH memory used in solid state disks (SSD), and different from SRAM and DRAM which are volatile;

(2) lower power consumption than volatile memories such as SRAM and DRAM;

(3) random access similar to SRAM and DRAM (also known as randomly addressable);

(4) rewritable and erasable at a lower level of granularity (e.g., byte level) than FLASH found in SSDs (which can only be rewritten and erased a “block” at a time—minimally 64 Kbyte in size for NOR FLASH and 16 Kbyte for NAND FLASH);

(5) used as a system memory and allocated all or a portion of the system memory address space;

(6) capable of being coupled to the processor over a bus using a transactional protocol (a protocol that supports transaction identifiers (IDs) to distinguish different transactions so that those transactions can complete out-of-order) and allowing access at a level of granularity small enough to support operation of the NVRAM as system memory (e.g., cache line size such as 64 or 128 byte). For example, the bus may be a memory bus (e.g., a DDR bus such as DDR3, DDR4, etc.) over which is run a transactional protocol as opposed to the non-transactional protocol that is normally used. As another example, the bus may one over which is normally run a transactional protocol (a native transactional protocol), such as a PCI express (PCIE) bus, desktop management interface (DMI) bus, or any other type of bus utilizing a transactional protocol and a small enough transaction payload size (e.g., cache line size such as 64 or 128 byte); and

(7) one or more of the following:
a) faster write speed than non-volatile memory/storage technologies such as FLASH;
b) very high read speed (faster than FLASH and near or equivalent to DRAM read speeds);
c) directly writable (rather than requiring erasing (overwriting with 1s) before writing data like FLASH memory used in SSDs);
d) a greater number of writes before failure (more than boot ROM and FLASH used in SSDs); and/or

As mentioned above, in contrast to FLASH memory, which must be rewritten and erased a complete “block” at a time, the level of granularity at which NVRAM is accessed in any given implementation may depend on the particular memory controller and the particular memory bus or other type of bus to which the NVRAM is coupled. For example, in some implementations where NVRAM is used as system memory, the NVRAM may be accessed at the granularity of a cache line (e.g., a 64-byte or 128-Byte cache line), notwithstanding an inherent ability to be accessed at the granularity of a byte, because cache line is the level at which the memory subsystem accesses memory. Thus, when NVRAM is deployed within a memory subsystem, it may be accessed at the same level of granularity as the DRAM (e.g., the “near memory”) used in the same memory subsystem. Even so, the level of granularity of access to the NVRAM by the memory controller and memory bus or other type of bus is smaller than that of the block size used by Flash and the access size of the I/O subsystem's controller and bus.

NVRAM may also incorporate wear leveling algorithms to account for the fact that the storage cells at the far memory level begin to wear out after a number of write accesses, especially where a significant number of writes may occur such as in a system memory implementation. Since high cycle count blocks are most likely to wear out in this manner, wear leveling spreads writes across the far memory cells by swapping addresses of high cycle count blocks with low cycle count blocks. Note that most address swapping is typically transparent to application programs_because it is handled by hardware, lower-level software (e.g., a low level driver or operating system), or a combination of the two.

B. Far Memory

The far memory 122 of some embodiments of the invention is implemented with NVRAM, but is not necessarily limited to any particular memory technology. Far memory 122 is distinguishable from other instruction and data memory/storage technologies in terms of its characteristics and/or its application in the memory/storage hierarchy. For example, far memory 122 is different from:
1) static random access memory (SRAM) which may be used for level 0 and level 1 internal processor caches 101a-b, 102a-b, 103a-b, 103a-b, and 104a-b dedicated to each of the processor cores 101-104, respectively, and lower level cache (LLC) 105 shared by the processor cores;
2) dynamic random access memory (DRAM) configured as a cache 106 internal to the processor 100 (e.g., on the same die as the processor 100) and/or configured as one or more caches 107-109 external to the processor (e.g., in the same or a different package from the processor 100); and
3) FLASH memory/magnetic disk/optical disc applied as mass storage (not shown); and
4) memory such as FLASH memory or other read only memory (ROM) applied as firmware memory (which can refer to boot ROM, BIOS Flash, and/or TPM Flash). (not shown).

Far memory 122 may be used as instruction and data storage that is directly addressable by a processor 100 and is able to sufficiently keep pace with the processor 100 in contrast to FLASH/magnetic disk/optical disc applied as mass storage. Moreover, as discussed above and described in detail below, far memory 122 may be placed on a memory bus and may communicate directly with a memory controller that, in turn, communicates directly with the processor 100.

Far memory 122 may be combined with other instruction and data storage technologies (e.g., DRAM) to form hybrid memories (also known as Co-locating PCM and DRAM; first level memory and second level memory; FLAM (FLASH and DRAM)). Note that at least some of the above technologies, including PCM/PCMS may be used for mass storage instead of, or in addition to, system memory, and need not be random accessible, byte addressable or directly addressable by the processor when applied in this manner.

For convenience of explanation, most of the remainder of the application will refer to “NVRAM” or, more specifically, “PCM,” or “PCMS” as the technology selection for the far memory 122. As such, the terms NVRAM, PCM, PCMS, and far memory may be used interchangeably in the following discussion. However it should be realized, as discussed above, that different technologies may also be utilized for far memory. Also, that NVRAM is not limited for use as far memory.

C. Near Memory

“Near memory” 121 is an intermediate level of memory configured in front of a far memory 122 that has lower read/write access latency relative to far memory and/or more symmetric read/write access latency (i.e., having read times which are roughly equivalent to write times). In some embodiments, the near memory 121 has significantly lower write latency than the far memory 122 but similar (e.g., slightly lower or equal) read latency; for instance the near memory 121 may be a volatile memory such as volatile random access memory (VRAM) and may comprise a DRAM or other high speed capacitor-based memory. Note, however, that the underlying principles of the invention are not limited to these specific memory types. Additionally, the near memory 121 may have a relatively lower density and/or may be more expensive to manufacture than the far memory 122.

In one embodiment, near memory 121 is configured between the far memory 122 and the internal processor caches 120. In some of the embodiments described below, near memory 121 is configured as one or more memory-side caches (MSCs) 107-109 to mask the performance and/or usage limitations of the far memory including, for example, read/write latency limitations and memory degradation limitations. In these implementations, the combination of the MSC 107-109 and far memory 122 operates at a performance level which approximates, is equivalent or exceeds a system which uses only DRAM as system memory. As discussed in detail below, although shown as a “cache” in FIG. 1, the near memory 121 may include modes in which it performs other roles, either in addition to, or in lieu of, performing the role of a cache.

Near memory 121 can be located on the processor die (as cache(s) 106) and/or located external to the processor die (as caches 107-109) (e.g., on a separate die located on the CPU package, located outside the CPU package with a high bandwidth link to the CPU package, for example, on a memory dual in-line memory module (DIMM), a riser/mezzanine, or a computer motherboard). The near memory 121 may be coupled in communicate with the processor 100 using a single or multiple high bandwidth links, such as DDR or other transactional high bandwidth links (as described in detail below).

### An Exemplary System Memory Allocation Scheme

FIG. 1 illustrates how various levels of caches 101-109 are configured with respect to a system physical address (SPA) space 116-119 in embodiments of the invention. As mentioned, this embodiment comprises a processor 100 having one or more cores 101-104, with each core having its own dedicated upper level cache (L0) 101a-104a and mid-level cache (MLC) (L1) cache 101b-104b. The processor 100 also includes a shared LLC 105. The operation of these various cache levels are well understood and will not be described in detail here.

The caches 107-109 illustrated in FIG. 1 may be dedicated to a particular system memory address range or a set of non-contiguous address ranges. For example, cache 107 is dedicated to acting as an MSC for system memory address range #1 116 and caches 108 and 109 are dedicated to acting as MSCs for non-overlapping portions of system memory address ranges #2 117 and #3 118. The latter implementation may be used for systems in which the SPA space used by the processor 100 is interleaved into an address space used by the caches 107-109 (e.g., when configured as MSCs). In some embodiments, this latter address space is referred to as a memory channel address (MCA) space. In one embodiment, the internal caches 101a-106 perform caching operations for the entire SPA space.

System memory as used herein is memory which is visible to and/or directly addressable by software executed on the processor 100; while the cache memories 101a-109 may operate transparently to the software in the sense that they do not form a directly-addressable portion of the system address space, but the cores may also support execution of instructions to allow software to provide some control (configuration, policies, hints, etc.) to some or all of the cache(s). The subdivision of system memory into regions 116-119 may be performed manually as part of a system configuration process (e.g., by a system designer) and/or may be performed automatically by software.

In one embodiment, the system memory regions 116-119 are implemented using far memory (e.g., PCM) and, in some embodiments, near memory configured as system memory. System memory address range #4 represents an address range which is implemented using a higher speed memory such as DRAM which may be a near memory configured in a system memory mode (as opposed to a caching mode).

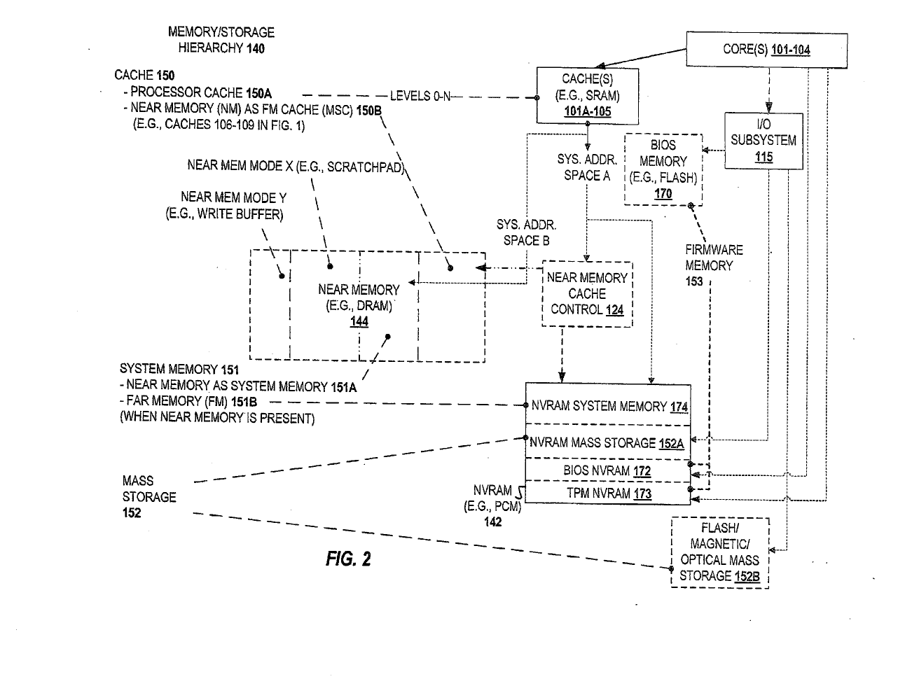

FIG. 2 illustrates a memory/storage hierarchy 140 and different configurable modes of operation for near memory 144 and NVRAM according to embodiments of the invention. The memory/storage hierarchy 140 has multiple levels including (1) a cache level 150 which may include processor caches 150A (e.g., caches 101A-105 in FIG. 1) and optionally near memory as cache for far memory 150B (in certain modes of operation as described herein), (2) a system memory level 151 which may include far memory 151B (e.g., NVRAM such as PCM) when near memory is present (or just NVRAM as system memory 174 when near memory is not present), and optionally near memory operating as system memory 151A (in certain modes of operation as described herein), (3) a mass storage level 152 which may include a flash/magnetic/optical mass storage 152B and/or NVRAM mass storage 152A (e.g., a portion of the NVRAM 142); and (4) a firmware memory level 153 that may include BIOS flash 170 and/or BIOS NVRAM 172 and optionally trusted platform module (TPM) NVRAM 173.

As indicated, near memory 144 may be implemented to operate in a variety of different modes including: a first mode in which it operates as a cache for far memory (near memory as cache for FM 150B); a second mode in which it operates as system memory 151A and occupies a portion of the SPA space (sometimes referred to as near memory “direct access” mode); and one or more additional modes of operation such as a scratchpad memory 192 or as a write buffer 193. In some embodiments of the invention, the near memory is partitionable, where each partition may concurrently operate in a different one of the supported modes; and different embodiments may support configuration of the partitions (e.g., sizes, modes) by hardware (e.g., fuses, pins), firmware, and/or software (e.g., through a set of programmable range registers within the MSC controller 124 within which, for example, may be stored different binary codes to identify each mode and partition).

System address space A 190 in FIG. 2 is used to illustrate operation when near memory is configured as a MSC for far memory 150B. In this configuration, system address space A 190 represents the entire system address space (and system address space B 191 does not exist). Alternatively, system address space B 191 is used to show an implementation when all or a portion of near memory is assigned a portion of the system address space. In this embodiment, system address space B 191 represents the range of the system address space assigned to the near memory 151A and system address space A 190 represents the range of the system address space assigned to NVRAM 174.

In addition, when acting as a cache for far memory 150B, the near memory 144 may operate in various sub-modes under the control of the MSC controller 124. In each of these modes, the near memory address space (NMA) is transparent to software in the sense that the near memory does not form a directly-addressable portion of the system address space. These modes include but are not limited to the following:

(1) Write-Back Caching Mode: In this mode, all or portions of the near memory acting as a FM cache 150B is used as a cache for the NVRAM far memory (FM) 151B. While in write-back mode, every write operation is directed initially to the near memory as cache for FM 150B (assuming that the cache line to which the write is directed is present in the cache). A corresponding write operation is performed to update the NVRAM FM 151B only when the cache line within the near memory as cache for FM 150B is to be replaced by another cache line (in contrast to write-through mode described below in which each write operation is immediately propagated to the NVRAM FM 151B).

(2) Near Memory Bypass Mode: In this mode all reads and writes bypass the NM acting as a FM cache 150B and go directly to the NVRAM FM 151B. Such a mode may be used, for example, when an application is not cache friendly or requires data to be committed to persistence at the granularity of a cache line. In one embodiment, the caching performed by the processor caches 150A and the NM acting as a FM cache 150B operate independently of one another. Consequently, data may be cached in the NM acting as a FM cache 150B which is not cached in the processor caches 150A (and which, in some cases, may not be permitted to be cached in the processor caches 150A) and vice versa. Thus, certain data which may be designated as “uncacheable” in the processor caches may be cached within the NM acting as a FM cache 150B.

(3) Near Memory Read-Cache Write Bypass Mode: This is a variation of the above mode where read caching of the persistent data from NVRAM FM 151B is allowed (i.e., the persistent data is cached in the near memory as cache for far memory 150B for read-only operations). This is useful when most of the persistent data is “Read-Only” and the application usage is cache-friendly.

(4) Near Memory Read-Cache Write-Through Mode: This is a variation of the near memory read-cache write bypass mode, where in addition to read caching, write-hits are also cached. Every write to the near memory as cache for FM 150B causes a write to the FM 151B. Thus, due to the write-through nature of the cache, cache-line persistence is still guaranteed.

When acting in near memory direct access mode, all or portions of the near memory as system memory 151A are directly visible to software and form part of the SPA space. Such memory may be completely under software control. Such a scheme may create a non-uniform memory address (NUMA) memory domain for software where it gets higher performance from near memory 144 relative to NVRAM system memory 174. By way of example, and not limitation, such a usage may be employed for certain high performance computing (HPC) and graphics applications which require very fast access to certain data structures.

In an alternate embodiment, the near memory direct access mode is implemented by “pinning” certain cache lines in near memory (i.e., cache lines which have data that is also concurrently stored in NVRAM 142). Such pinning may be done effectively in larger, multi-way, set-associative caches.

FIG. 2 also illustrates that a portion of the NVRAM 142 may be used as firmware memory. For example, the BIOS NVRAM 172 portion may be used to store BIOS images (instead of or in addition to storing the BIOS information in BIOS flash 170). The BIOS NVRAM portion 172 may be a portion of the SPA space and is directly addressable by software executed on the processor cores 101-104, whereas the BIOS flash 170 is addressable through the I/O subsystem 115. As another example, a trusted platform module (TPM) NVRAM 173 portion may be used to protect sensitive system information (e.g., encryption keys).

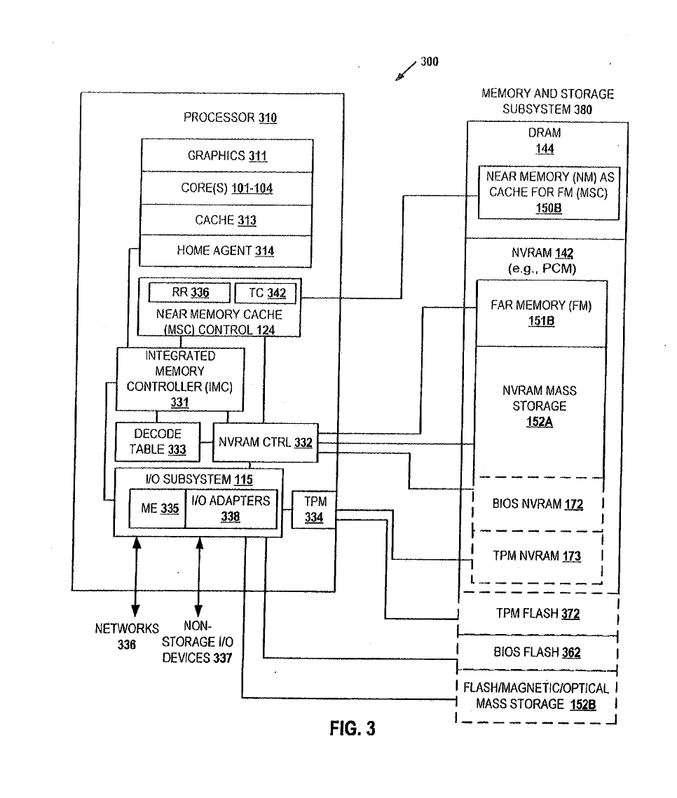

Thus, as indicated, the NVRAM 142 may be implemented to operate in a variety of different modes, including as far memory 151B (e.g., when near memory 144 is present/operating, whether the near memory is acting as a cache for the FM via a MSC control 124 or not (accessed directly after cache(s) 101A-105 and without MSC control 124)); just NVRAM system memory 174 (not as far memory because there is no near memory present/operating; and accessed without MSC control 124); NVRAM mass storage 152A; BIOS NVRAM 172; and TPM NVRAM 173. While different embodiments may specify the NVRAM modes in different ways, FIG. 3 describes the use of a decode table 333.

FIG. 3 illustrates an exemplary computer system 300 on which embodiments of the invention may be implemented. The computer system 300 includes a processor 310 and memory/storage subsystem 380 with a NVRAM 142 used for both system memory, mass storage, and optionally firmware memory. In one embodiment, the NVRAM 142 comprises the entire system memory and storage hierarchy used by computer system 300 for storing data, instructions, states, and other persistent and non-persistent information. As previously discussed, NVRAM 142 can be configured to implement the roles in a typical memory and storage hierarchy of system memory, mass storage, and firmware memory, TPM memory, and the like. In the embodiment of FIG. 3, NVRAM 142 is partitioned into FM 151B, NVRAM mass storage 152A, BIOS NVRAM 173, and TMP NVRAM 173. Storage hierarchies with different roles are also contemplated and the application of NVRAM 142 is not limited to the roles described above.

By way of example, operation while the near memory as cache for FM 150B is in the write-back caching is described. In one embodiment, while the near memory as cache for FM 150B is in the write-back caching mode mentioned above, a read operation will first arrive at the MSC controller 124 which will perform a look-up to determine if the requested data is present in the near memory acting as a cache for FM 150B (e.g., utilizing a tag cache 342). If present, it will return the data to the requesting CPU, core 101-104 or I/O device through I/O subsystem 115. If the data is not present, the MSC controller 124 will send the request along with the system memory address to an NVRAM controller 332. The NVRAM controller 332 will use the decode table 333 to translate the system memory address to an NVRAM physical device address (PDA) and direct the read operation to this region of the far memory 151B. In one embodiment, the decode table 333 includes an address indirection table (AIT) component which the NVRAM controller 332 uses to translate between system memory addresses and NVRAM PDAs. In one embodiment, the AIT is updated as part of the wear leveling algorithm implemented to distribute memory access operations and thereby reduce wear on the NVRAM FM 151B. Alternatively, the AIT may be a separate table stored within the NVRAM controller 332.

Upon receiving the requested data from the NVRAM FM 151B, the NVRAM controller 332 will return the requested data to the MSC controller 124 which will store the data in the MSC near memory acting as an FM cache 150B and also send the data to the requesting processor core 101-104, or I/O Device through I/O subsystem 115. Subsequent requests for this data may be serviced directly from the near memory acting as a FM cache 150B until it is replaced by some other NVRAM FM data.

As mentioned, in one embodiment, a memory write operation also first goes to the MSC controller 124 which writes it into the MSC near memory acting as a FM cache 150B. In write-back caching mode, the data may not be sent directly to the NVRAM FM 151B when a write operation is received. For example, the data may be sent to the NVRAM FM 151B only when the location in the MSC near memory acting as a FM cache 150B in which the data is stored must be re-used for storing data for a different system memory address. When this happens, the MSC controller 124 notices that the data is not current in NVRAM FM 151B and will thus retrieve it from near memory acting as a FM cache 150B and send it to the NVRAM controller 332. The NVRAM controller 332 looks up the PDA for the system memory address and then writes the data to the NVRAM FM 151B.

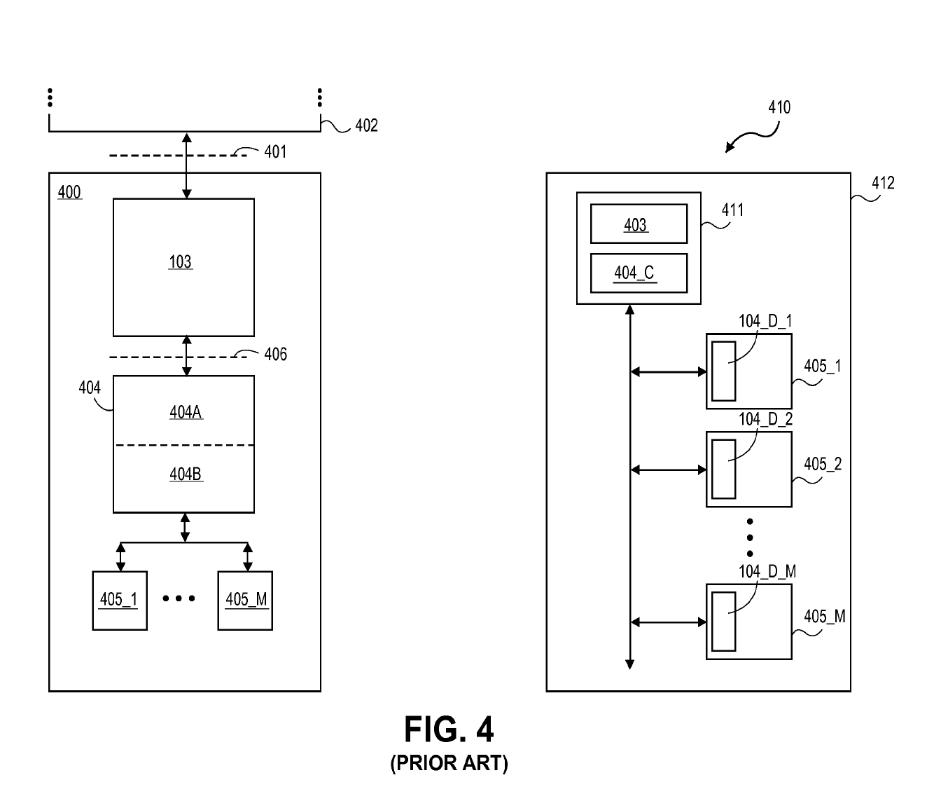

In FIG. 3, the NVRAM controller 332 is shown connected to the FM 151B, NVRAM mass storage 152A, and BIOS NVRAM 172 using three separate lines. This does not necessarily mean, however, that there are three separate physical buses or communication channels connecting the NVRAM controller 332 to these portions of the NVRAM 142. Rather, in some embodiments, a common memory bus or other type of bus (such as those described below with respect to FIGS. 4A-M) is used to communicatively couple the NVRAM controller 332 to the FM 151B, NVRAM mass storage 152A, and BIOS NVRAM 172. For example, in one embodiment, the three lines in FIG. 3 represent a bus, such as a memory bus (e.g., a DDR3, DDR4, etc, bus), over which the NVRAM controller 332 implements a transactional protocol to communicate with the NVRAM 142. The NVRAM controller 332 may also communicate with the NVRAM 142 over a bus supporting a native transactional protocol such as a PCI express bus, desktop management interface (DMI) bus, or any other type of bus utilizing a transactional protocol and a small enough transaction payload size (e.g., cache line size such as 64 or 128 byte).

In one embodiment, computer system 300 includes integrated memory controller (IMC) 331 which performs the central memory access control for processor 310, which is coupled to: 1) a memory-side cache (MSC) controller 124 to control access to near memory (NM) acting as a far memory cache 150B; and 2) a NVRAM controller 332 to control access to NVRAM 142. Although illustrated as separate units in FIG. 3, the MSC controller 124 and NVRAM controller 332 may logically form part of the IMC 331.

In the illustrated embodiment, the MSC controller 124 includes a set of range registers 336 which specify the mode of operation in use for the NM acting as a far memory cache 150B (e.g., write-back caching mode, near memory bypass mode, etc, described above). In the illustrated embodiment, DRAM 144 is used as the memory technology for the NM acting as cache for far memory 150B. In response to a memory access request, the MSC controller 124 may determine (depending on the mode of operation specified in the range registers 336) whether the request can be serviced from the NM acting as cache for FM 150B or whether the request must be sent to the NVRAM controller 332, which may then service the request from the far memory (FM) portion 151B of the NVRAM 142.

In an embodiment where NVRAM 142 is implemented with PCMS, NVRAM controller 332 is a PCMS controller that performs access with protocols consistent with the PCMS technology. As previously discussed, the PCMS memory is inherently capable of being accessed at the granularity of a byte. Nonetheless, the NVRAM controller 332 may access a PCMS-based far memory 151B at a lower level of granularity such as a cache line (e.g., a 64-bit or 128-bit cache line) or any other level of granularity consistent with the memory subsystem. The underlying principles of the invention are not limited to any particular level of granularity for accessing a PCMS-based far memory 151B. In general, however, when PCMS-based far memory 151B is used to form part of the system address space, the level of granularity will be higher than that traditionally used for other non-volatile storage technologies such as FLASH, which can only perform rewrite and erase operations at the level of a “block” (minimally 64 Kbyte in size for NOR FLASH and 16 Kbyte for NAND FLASH).

In the illustrated embodiment, NVRAM controller 332 can read configuration data to establish the previously described modes, sizes, etc. for the NVRAM 142 from decode table 333, or alternatively, can rely on the decoding results passed from IMC 331 and I/O subsystem 315. For example, at either manufacturing time or in the field, computer system 300 can program decode table 333 to mark different regions of NVRAM 142 as system memory, mass storage exposed via SATA interfaces, mass storage exposed via USB Bulk Only Transport (BOT) interfaces, encrypted storage that supports TPM storage, among others. The means by which access is steered to different partitions of NVRAM device 142 is via a decode logic. For example, in one embodiment, the address range of each partition is defined in the decode table 333. In one embodiment, when IMC 331 receives an access request, the target address of the request is decoded to reveal whether the request is directed toward memory, NVRAM mass storage, or I/O. If it is a memory request, IMC 331 and/or the MSC controller 124 further determines from the target address whether the request is directed to NM as cache for FM 150B or to FM 151B. For FM 151B access, the request is forwarded to NVRAM controller 332. IMC 331 passes the request to the I/O subsystem 115 if this request is directed to I/O (e.g., non-storage and storage I/O devices). I/O subsystem 115 further decodes the address to determine whether the address points to NVRAM mass storage 152A, BIOS NVRAM 172, or other non-storage or storage I/O devices. If this address points to NVRAM mass storage 152A or BIOS NVRAM 172, I/O subsystem 115 forwards the request to NVRAM controller 332. If this address points to TMP NVRAM 173, I/O subsystem 115 passes the request to TPM 334 to perform secured access.

In one embodiment, each request forwarded to NVRAM controller 332 is accompanied with an attribute (also known as a “transaction type”) to indicate the type of access. In one embodiment, NVRAM controller 332 may emulate the access protocol for the requested access type, such that the rest of the platform remains unaware of the multiple roles performed by NVRAM 142 in the memory and storage hierarchy. In alternative embodiments, NVRAM controller 332 may perform memory access to NVRAM 142 regardless of which transaction type it is. It is understood that the decode path can be different from what is described above. For example, IMC 331 may decode the target address of an access request and determine whether it is directed to NVRAM 142. If it is directed to NVRAM 142, IMC 331 generates an attribute according to decode table 333. Based on the attribute, IMC 331 then forwards the request to appropriate downstream logic (e.g., NVRAM controller 332 and I/O subsystem 315) to perform the requested data access. In yet another embodiment, NVRAM controller 332 may decode the target address if the corresponding attribute is not passed on from the upstream logic (e.g., IMC 331 and I/O subsystem 315). Other decode paths may also be implemented.

The presence of a new memory architecture such as described herein provides for a wealth of new possibilities. Although discussed at much greater length further below, some of these possibilities are quickly highlighted immediately below.

According to one possible implementation, NVRAM 142 acts as a total replacement or supplement for traditional DRAM technology in system memory. In one embodiment, NVRAM 142 represents the introduction of a second-level system memory (e.g., the system memory may be viewed as having a first level system memory comprising near memory as cache 150B (part of the DRAM device 340) and a second level system memory comprising far memory (FM) 151B (part of the NVRAM 142).

According to some embodiments, NVRAM 142 acts as a total replacement or supplement for the flash/magnetic/optical mass storage 152B. As previously described, in some embodiments, even though the NVRAM 152A is capable of byte-level addressability, NVRAM controller 332 may still access NVRAM mass storage 152A in blocks of multiple bytes, depending on the implementation (e.g., 64 Kbytes, 128 Kbytes, etc.). The specific manner in which data is accessed from NVRAM mass storage 152A by NVRAM controller 332 may be transparent to software executed by the processor 310. For example, even through NVRAM mass storage 152A may be accessed differently from Flash/magnetic/optical mass storage 152A, the operating system may still view NVRAM mass storage 152A as a standard mass storage device (e.g., a serial ATA hard drive or other standard form of mass storage device).

In an embodiment where NVRAM mass storage 152A acts as a total replacement for the flash/magnetic/optical mass storage 152B, it is not necessary to use storage drivers for block-addressable storage access. The removal of storage driver overhead from storage access can increase access speed and save power. In alternative embodiments where it is desired that NVRAM mass storage 152A appears to the OS and/or applications as block-accessible and indistinguishable from flash/magnetic/optical mass storage 152B, emulated storage drivers can be used to expose block-accessible interfaces (e.g., Universal Serial Bus (USB) Bulk-Only Transfer (BOT), 1.0; Serial Advanced Technology Attachment (SATA), 3.0; and the like) to the software for accessing NVRAM mass storage 152A.

In one embodiment, NVRAM 142 acts as a total replacement or supplement for firmware memory such as BIOS flash 362 and TPM flash 372 (illustrated with dotted lines in FIG. 3 to indicate that they are optional). For example, the NVRAM 142 may include a BIOS NVRAM 172 portion to supplement or replace the BIOS flash 362 and may include a TPM NVRAM 173 portion to supplement or replace the TPM flash 372. Firmware memory can also store system persistent states used by a TPM 334 to protect sensitive system information (e.g., encryption keys). In one embodiment, the use of NVRAM 142 for firmware memory removes the need for third party flash parts to store code and data that are critical to the system operations.

Continuing then with a discussion of the system of FIG. 3, in some embodiments, the architecture of computer system 100 may include multiple processors, although a single processor 310 is illustrated in FIG. 3 for simplicity. Processor 310 may be any type of data processor including a general purpose or special purpose central processing unit (CPU), an application-specific integrated circuit (ASIC) or a digital signal processor (DSP). For example, processor 310 may be a general-purpose processor, such as a Core™ i3, i5, i7, 2 Duo and Quad, Xeon™, or Itanium™ processor, all of which are available from Intel Corporation, of Santa Clara, Calif. Alternatively, processor 310 may be from another company, such as ARM Holdings, Ltd, of Sunnyvale, Calif., MIPS Technologies of Sunnyvale, Calif., etc. Processor 310 may be a special-purpose processor, such as, for example, a network or communication processor, compression engine, graphics processor, co-processor, embedded processor, or the like. Processor 310 may be implemented on one or more chips included within one or more packages. Processor 310 may be a part of and/or may be implemented on one or more substrates using any of a number of process technologies, such as, for example, BiCMOS, CMOS, or NMOS. In the embodiment shown in FIG. 3, processor 310 has a system-on-a-chip (SOC) configuration.

In one embodiment, the processor 310 includes an integrated graphics unit 311 which includes logic for executing graphics commands such as 3D or 2D graphics commands. While the embodiments of the invention are not limited to any particular integrated graphics unit 311, in one embodiment, the graphics unit 311 is capable of executing industry standard graphics commands such as those specified by the Open GL and/or Direct X application programming interfaces (APIs) (e.g., OpenGL 4.1 and Direct X 11).

The processor 310 may also include one or more cores 101-104, although a single core is illustrated in FIG. 3, again, for the sake of clarity. In many embodiments, the core(s) 101-104 includes internal functional blocks such as one or more execution units, retirement units, a set of general purpose and specific registers, etc. If the core(s) are multi-threaded or hyper-threaded, then each hardware thread may be considered as a “logical” core as well. The cores 101-104 may be homogenous or heterogeneous in terms of architecture and/or instruction set. For example, some of the cores may be in order while others are out-of-order. As another example, two or more of the cores may be capable of executing the same instruction set, while others may be capable of executing only a subset of that instruction set or a different instruction set.

The processor 310 may also include one or more caches, such as cache 313 which may be implemented as a SRAM and/or a DRAM. In many embodiments that are not shown, additional caches other than cache 313 are implemented so that multiple levels of cache exist between the execution units in the core(s) 101-104 and memory devices 150B and 151B. For example, the set of shared cache units may include an upper-level cache, such as a level 1 (L1) cache, mid-level caches, such as level 2 (L2), level 3 (L3), level 4 (L4), or other levels of cache, an (LLC), and/or different combinations thereof. In different embodiments, cache 313 may be apportioned in different ways and may be one of many different sizes in different embodiments. For example, cache 313 may be an 8 megabyte (MB) cache, a 16 MB cache, etc. Additionally, in different embodiments the cache may be a direct mapped cache, a fully associative cache, a multi-way set-associative cache, or a cache with another type of mapping. In other embodiments that include multiple cores, cache 313 may include one large portion shared among all cores or may be divided into several separately functional slices (e.g., one slice for each core). Cache 313 may also include one portion shared among all cores and several other portions that are separate functional slices per core.

The processor 310 may also include a home agent 314 which includes those components coordinating and operating core(s) 101-104. The home agent unit 314 may include, for example, a power control unit (PCU) and a display unit. The PCU may be or include logic and components needed for regulating the power state of the core(s) 101-104 and the integrated graphics unit 311. The display unit is for driving one or more externally connected displays.

As mentioned, in some embodiments, processor 310 includes an integrated memory controller (IMC) 331, near memory cache (MSC) controller, and NVRAM controller 332 all of which can be on the same chip as processor 310, or on a separate chip and/or package connected to processor 310. DRAM device 144 may be on the same chip or a different chip as the IMC 331 and MSC controller 124; thus, one chip may have processor 310 and DRAM device 144; one chip may have the processor 310 and another the DRAM device 144 and (these chips may be in the same or different packages); one chip may have the core(s) 101-104 and another the IMC 331, MSC controller 124 and DRAM 144 (these chips may be in the same or different packages); one chip may have the core(s) 101-104, another the IMC 331 and MSC controller 124, and another the DRAM 144 (these chips may be in the same or different packages); etc.

In some embodiments, processor 310 includes an I/O subsystem 115 coupled to IMC 331. I/O subsystem 115 enables communication between processor 310 and the following serial or parallel I/O devices: one or more networks 336 (such as a Local Area Network, Wide Area Network or the Internet), storage I/O device (such as flash/magnetic/optical mass storage 152B, BIOS flash 362, TPM flash 372) and one or more non-storage I/O devices 337 (such as display, keyboard, speaker, and the like). I/O subsystem 115 may include a platform controller hub (PCH) (not shown) that further includes several I/O adapters 338 and other I/O circuitry to provide access to the storage and non-storage I/O devices and networks. To accomplish this, I/O subsystem 115 may have at least one integrated I/O adapter 338 for each I/O protocol utilized. I/O subsystem 115 can be on the same chip as processor 310, or on a separate chip and/or package connected to processor 310.

I/O adapters 338 translate a host communication protocol utilized within the processor 310 to a protocol compatible with particular I/O devices. For flash/magnetic/optical mass storage 152B, some of the protocols that I/O adapters 338 may translate include Peripheral Component Interconnect (PCI)-Express (PCI-E), 3.0; USB, 3.0; SATA, 3.0; Small Computer System Interface (SCSI), Ultra-640; and Institute of Electrical and Electronics Engineers (IEEE) 1394 “Firewire;” among others. For BIOS flash 362, some of the protocols that I/O adapters 338 may translate include Serial Peripheral Interface (SPI), Microwire, among others. Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

In some embodiments, the I/O subsystem 115 is coupled to a TPM control 334 to control access to system persistent states, such as secure data, encryption keys, platform configuration information and the like. In one embodiment, these system persistent states are stored in a TMP NVRAM 173 and accessed via NVRAM controller 332.

In one embodiment, TPM 334 is a secure micro-controller with cryptographic functionalities. TPM 334 has a number of trust-related capabilities; e.g., a SEAL capability for ensuring that data protected by a TPM is only available for the same TPM. TPM 334 can protect data and keys (e.g., secrets) using its encryption capabilities. In one embodiment, TPM 334 has a unique and secret RSA key, which allows it to authenticate hardware devices and platforms. For example, TPM 334 can verify that a system seeking access to data stored in computer system 300 is the expected system. TPM 334 is also capable of reporting the integrity of the platform (e.g., computer system 300). This allows an external resource (e.g., a server on a network) to determine the trustworthiness of the platform but does not prevent access to the platform by the user.

In some embodiments, I/O subsystem 315 also includes a Management Engine (ME) 335, which is a microprocessor that allows a system administrator to monitor, maintain, update, upgrade, and repair computer system 300. In one embodiment, a system administrator can remotely configure computer system 300 by editing the contents of the decode table 333 through ME 335 via networks 336.

For convenience of explanation, the remainder of the application sometimes refers to NVRAM 142 as a PCMS device. A PCMS device includes multi-layered (vertically stacked) PCM cell arrays that are non-volatile, have low power consumption, and are modifiable at the bit level. As such, the terms NVRAM device and PCMS device may be used interchangeably in the following discussion. However it should be realized, as discussed above, that different technologies besides PCMS may also be utilized for NVRAM 142.

It should be understood that a computer system can utilize NVRAM 142 for system memory, mass storage, firmware memory and/or other memory and storage purposes even if the processor of that computer system does not have all of the above-described components of processor 310, or has more components than processor 310.

In the particular embodiment shown in FIG. 3, the MSC controller 124 and NVRAM controller 332 are located on the same die or package (referred to as the CPU package) as the processor 310. In other embodiments, the MSC controller 124 and/or NVRAM controller 332 may be located off-die or off-CPU package, coupled to the processor 310 or CPU package over a bus such as a memory bus (like a DDR bus (e.g., a DDR3, DDR4, etc)), a PCI express bus, a desktop management interface (DMI) bus, or any other type of bus.

### Thin Translation for System Access of Non Volatile Semiconductor Storage as Random Access Memory

FIG. 4 shows a depiction of the structure of a prior art FLASH storage device 400. A FLASH storage device is a device having FLASH memory devices that serve as a data storage resource for a larger (e.g., computer) system 402. Notably, the system communicates to the FLASH storage device through FLASH storage device interface 401.

The storage device interface 401 defines a set of communication semantics between the system 402 and the storage device 400 itself. Defining the communication interface 401 permits system designers to design a system that extends only so far as the interface 401 and permits FLASH storage device designers to understand what commands their device is expected to handle and what the appropriate responses to those commands are supposed to be.

In a common implementation, a read or write command is transported over a physical layer through the data storage device interface 401. Prior implementations of solid state disks (SSDs) have utilized SATA, SAS or Fibre Channel for the interface 401. Each of these standards define their own communicative protocol semantics and physical layer signaling and pin out specification. PCIe has been used for the physical layer signaling and pin out definition of the interface 401 for other implementations but with an overlying communication protocol semantic that is specific to the particular SSD manufacturer.

Relatively recently, an industry group has formed the NVM Express (NVMe) specification (which is derived from a preceding specification entitled Non-Volatile Memory Host Controller Interface Specification (NVMHCI)) that seeks to standardize the FLASH storage device interface 401 using a PCIe physical layer.

At least with respect to the NVMe approach, a FLASH storage device 400 that receives read and write commands from a system 402 through interface 401 can be viewed as including two layers of internal communication protocol technologies. A first upper layer 403 supports the system level interface 401 and converts the commands received from the system 402 into commands that are specific to its internal FLASH memory devices 405_1 to 405_M. Here, it is pertinent to point out that an SSD is treated and/or viewed as a disk drive by the system 402 even though the actual storage technology is FLASH memory.

Upper layer 403 comprehends the distinction and essentially serves as a translation layer between a system 402 that is treating the storage as a disk drive and the actual FLASH based (non disk drive) storage. Moreover, upper layer 403 may include both inbound and outbound queuing (to accommodate for transactions where the target can not immediately service the request at hand). NVMe, for instance, is its own protocol, that incorporates buffering, data protection, metadata management, data placement, etc.

The second lower layer 404 provides a FLASH memory device interface 406 to the upper layer 403. Another industry effort, referred to as the Open NAND Flash Interface Working Group (ONFI), has defined an industry standard FLASH memory device interface 406 and underlying functions (such as ECC handling, read caching and device timing). Interface 406 and the underlying functions performed by layer 404 serve to “abstract away” from the perspective of layer 403 any differences that may exist in the behaviors of different FLASH memory devices that are utilized in different SSD devices, or, at least present a common interface for different FLASH device manufacturers.

A specific targeted channel and die may be identified through the FLASH memory device interface 406. Thus, FLASH memory device interface 406 (also referred to as a “NAND interface” (e.g., ONFI, Toggle Mode, etc.)) is a raw interface that allows pages to be written, ideally with multiple channels talking to multiple dies simultaneously for speed.

By contrast, the upper layer protocol 103 such as NVMe, SAS, SATA, etc. exposes block interfaces to the system which permit the host to write data to a block (which underneath within upper layer 103 is virtually mapped from a host logical block address (LBA), to an internal physical block address (in the case of an SSD, this refers to a channel, die, block, page, sector)). Therefore, one of the major elements (and most difficult parts) of an SSD is the metadata management function of the upper layer 103 (or how to relate an LBA to a PBA, where this relationship can change outside of the user's control, for example garbage collection, wear-leveling, etc.). Further, the upper layer 103 of the SSD makes assumptions about how to store/stripe/protect data.

FIG. 4 shows a typical hardware implementation of a FLASH storage device at inset 410. A controller semiconductor chip 411 is integrated in a same package 412 with the multiple FLASH memory devices 405_1 to 405_M. The upper layer 403 is implemented on controller 411. The lower layer 404 (including both its respective upper and lower layers 404a, 404b discussed in more detail below) has a controller side portion 404_C and memory device side portions 405_1 to 405_M. Here, as part of implementing the FLASH memory commands received from the upper layer 403, the controller side portion of the lower layer 404_C interprets and physically sends the commands to the actual FLASH memory devices themselves 405_1 to 405_M which perform the requested operation.

As such, the second lower layer 404 itself can be viewed as having two distinctive layers 404a, 404b. A first upper layer 404a that, on the controller side, provides an abstract (e.g., technology independent) representation of the FLASH memory devices to upper layer 403, and, issues specific commands to specific FLASH memory devices to a second lower layer 404b in response to the commands received from upper layer 403.

The second lower layer 404b implements the actual electronic signaling (e.g., voltage levels, waveform characteristics, etc.) between the controller 411 and the FLASH memory devices 405_1 to 405_M and defines the mechanical specification including the number of pin outs on the controller 411 and each of the FLASH memory devices 405_1 to 405_M (and the role of each) used to effect successful communication between the controller 411 and memory devices 405_1 to 405_M. A memory device side instance of upper layer 404a resides on each FLASH device 405_1 to 405_M to receive commands from the controller side 404_C and apply them to its local storage cells (when it is the target of the command). In a typical implementation, the FLASH memory devices are integrated in the same package as the controller 411 including being integrated on the same die. The controller 411 and FLASH memory devices 405_1 to 405_M are also collectively integrated into a same package that, as a whole unit, is incorporated (e.g., “plugged” into) the larger system.

Notably, the lower layer 404b, at least as defined by ONFI, arguably consumes a disproportionate amount of substrate surface area because the I/O required of the controller and FLASH devices are high.

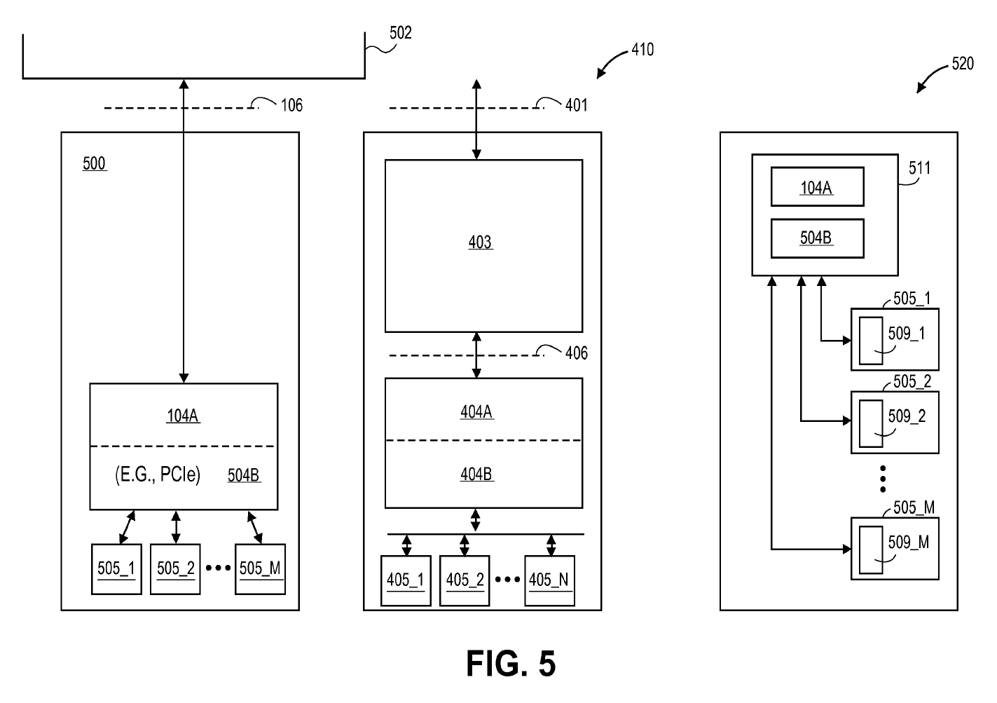

FIG. 5 shows a depiction of a non volatile memory storage device 500 that can behave as far memory (as opposed to a disk drive) that also should permit noticeably higher storage densities and lower latencies than solutions that fully implement the present ONFI specification. FIG. 5 also re-presents the inset 410 of FIG. 4 which shows a traditional FLASH based SSD device.

Comparing the two devices, note that the new device 500 does not include upper layer 403. Notably, the upper layer 404a of layer 404 remains. As such, in embodiments where the new device 500 is attached to the system 502 through PCIe, the system 502 “tunnels” ONFI commands to upper layer 404a through the PCIe host/device interconnect. ONFI formatted responses to those commands are likewise tunneled over the PCIe connection from the device 500 to the system 502. TOGGLE is an alternative to ONFI and can therefore also be used (as well as other current or future proprietary or standard non volatile random access memory or “NAND” interface technologies).

The removal of upper layer 403 means that the FLASH memory interface 406 (or other non volatile memory interface such as a PCMS interface), is presented to the system 502 directly. As such, the system 502 can address the non volatile memory devices 505_1 to 505_N directly as random access memories (rather than as a disk drive). As a consequence, among other possibilities, the system 502 can present addresses for cache lines and/or perform byte addressable operations rather than (as with a disk drive) only address large portions of data such as “sectors” or “logic blocks”. The system, may, for example, address the non volatile memory devices through interface 406 by specifying a particular channel and/or non volatile memory device.

As such a low-level “NAND” or other non volatile random access memory interface is exposed to the host/system. The system can then use this interface in a way that its sees as necessary. In one embodiment, the system could write data with ECC (e.g., XOR) information to enable reconstruction of data if a die or block is corrupted. In another embodiment, where the data is pure cache (and therefore requires no protection), the system could write singular copies of data, which is faster and maximizes the capacity of the available non volatile random access memories. Therefore, instead of a one-size fits all non volatile random access memory solution (using a heavyweight protocol), this approach provides a lightweight raw interface which allows the system to decide how the non volatile random access memory should be used.

Moreover, note that new device 500 and has replaced the lower physical layer portion 404b of lower layer 404 with a serial (point-to-point link based) physical layer 504b such as PCIe. Thus, according to one embodiment, the upper layer 404a of ONFI is utilized but the lower physical layer 404b is implemented with PCIe instead of ONFI's physical layer. In this implementation, the higher level (e.g., ONFI) upper layer 404a commands are also tunneled over PCIe to the non volatile memory devices 505_1 to 505_M. In an alternate approach, the ONFI lower physical later 404b is used instead of a point to point technology such as PCIe. For simplicity, the remainder of the document will refer to the new device 500 as having point to point interconnection technology at its respective non volatile memory devices.

The use of a link based physical layer 504b between the controller 511 and the non-volatile memory devices 505_1 to 505_M, as opposed to a full scale bus, at least reduces the I/O count as compared to the ONFI physical layer resulting in a smaller die package. The smaller package size combined with the power savings from the removal of the upper layer 403 (and whatever maximum power consumption format is permitted for the overall device/form factor), can be converted into more non volatile storage devices on the new device 500 as compared to the prior art solution of inset 410 of FIG. 4 (M instead of N where M>N). As such, the new device 500 should be able to provide larger storage capacities than the prior art solution 410 all other things being equal.

Here, for a same form factor as between the two devices 500 and 410 (e.g., comparing both solutions on a same PCIe form factor card), for the new device 500, the additional power budget made available from the removal of upper layer 403 can be consumed with the addition of additional non volatile memory devices 505_N+1 to 505_M. Here, the packing of such additional devices into a same form factor is made feasible through the lower I/O counts employed by the link based physical layer 504b between the controller and the non volatile memory devices 505_1 to 505_M (which, again, should result in a smaller die package size).

Besides increased storage density as compared to a fully implemented ONFI card, the new device 500, as a matter of comparison, should also have reduced latency. Specifically, the presence and operation of upper layer 403 on the prior art card 410 adds latency to any read/write transaction directed to the card that the new device 500 does not posses.

Moreover, if the new device is implemented on a PCIe card that plugs into a PCIe slot (i.e., interface 406 of FIG. 5 is implemented with a PCIe physical layer), the card will receive non-volatile memory interface commands (e.g., a PCMS interface commands or a FLASH interface commands such as an ONFI commands) within payloads of respective PCIe packets that are sent to the card by the system 502. Here, layer 404a corresponds to a thin translation layer that, for example, can retain much of the PCIe packet structure received from the system 502.

More specifically, layer 404a can behave akin to a packet forwarding device that makes modest adjustments to the received packet's header information (e.g., updating a destination address field to target a specific non volatile memory device) prior to the packet being re-launched through the internal PCIe physical layer 504b to a specific FLASH or PCMS device. In a further embodiment, the new destination address is determined from an address embedded in the payload of the PCIe packet received from the system 502 that is part of the FLASH or PCMS interface command issued by the system 502. The thin translation should correspond to noticeably smaller per transaction latency through the controller 511 of the new device 500 as compared to the prior art device 410.

Inset 520 of FIG. 5 shows a layout of the new design 500. A controller 511 includes the functionality of layer 404a (e.g., in dedicated logic circuitry, program code that is executed with instruction execution logic circuitry or a combination of both) and controller side portion of physical layer 504b. Each of the non volatile memory devices 505_1 to 505_M include device side instances 509_1 to 509_M of the physical layer 504b and layer 404a. Here, a device side instance of layer 404a is able to understand the commands sent to it by the controller side instance of layer 404a and cause them to take effect at its resident memory array. In one embodiment, the FLASH/PCMS memory devices 505_1 through 505_M are in the same respective package as the controller 511 (alternatively the memory dies and controller could be in different respective packages). The controller 411 and FLASH/PCMS memory devices 505_1 to 505_M are also collectively integrated into a same package that, as a whole unit, is incorporated (e.g., “plugged” into) the larger system 502.

The system component that may access the device 500 of FIG. 5 may be, for example, an NVRAM controller 332 and/or TPM 334 as discussed above with respect to FIG. 3. Alternatively or in combination, aspects of the NVRAM controller 332 and/or TPM 334 may be integrated into the controller 511 of FIG. 5.

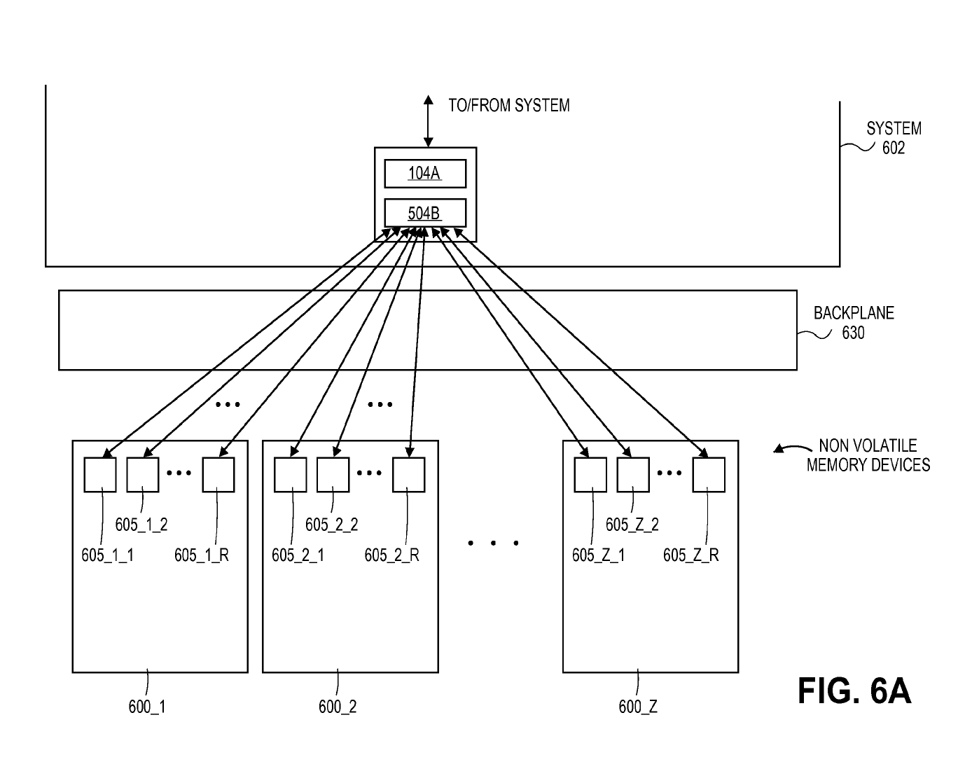

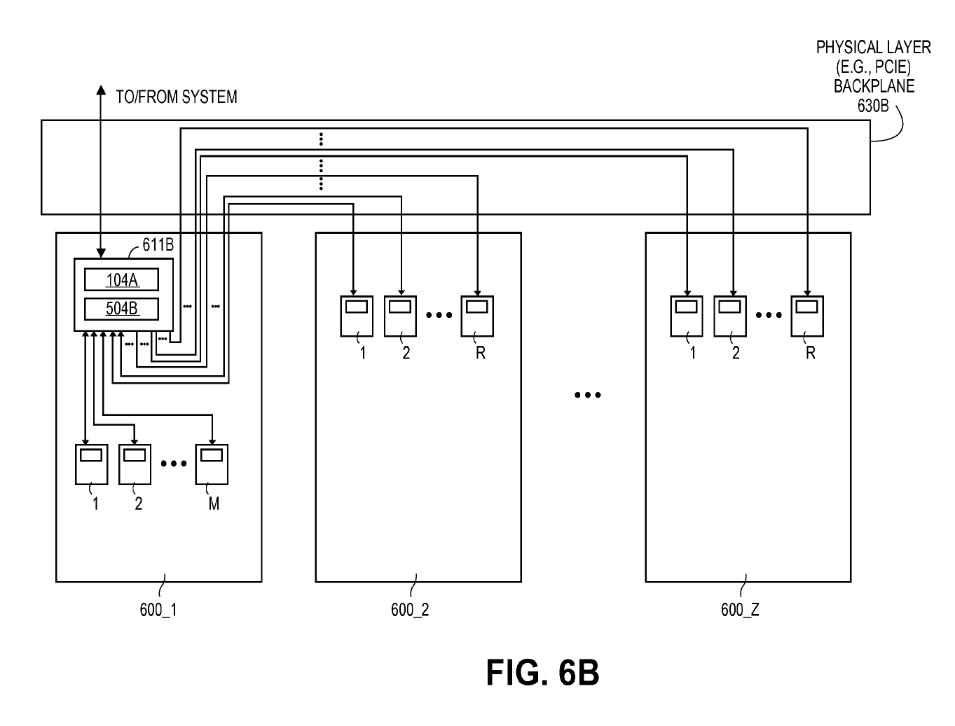

FIG. 6a shows an embodiment where the aforementioned function of controller 511 is moved up into the system (to controller 611a). Here, upper layers of the system may still communicate to the controller 611 through PCIe or some other communication technology internal to the system. Note, however, that if PCIe is the chosen mechanism for communicating to controller 611a, the solution presented in FIG. 6a can be easily integrated into the system's I/O hierarchy even though it may be treated more like a system memory.

Notably, the cards 600_1 to 600_Z that plug into the PCIe backplane 630a do not include a controller and communicate to the controller 611a directly through PCIe. As such, the non volatile memory devices themselves communicate directly to the system through PCIe. Here, controller 611a acts as a master hub or router of commands from the system to the other cards 600_1 to 600_Z. As cards 600_1 to 600_Z do not even have a controller, and instead receive upper layer 404a commands directly from the system (by way of controller 611a), even additional power and surface area savings are realized.

The additional power and surface area savings permit the population of even more non volatile memory devices on cards 600_1 through 600_Z (specifically, R memory devices where R>M). Further still, the lack of a controller on cards 600_1 through 600_Z should cause them to exhibit even more reduced latency on a per transaction basis than device 500 (which as discussed above should itself have reduced latency compared to the prior art solution of inset 410). As such, the backplane 630a having cards 600_1 through 600_Z plugged into it should exhibit noticeably greater storage density and smaller latencies than the same number of cards having fully implemented ONFI solutions.

With the controller 611a acting as a routing hub for cards 600_1 through 600_Z, a PCMS/FLASH memory interface command sent by the system to a memory device on any of cards 600_1 through Y00_Z is first sent to the controller. The controller 611a then forwards the command (e.g., by adding new destination address information to the packet received from the system) to the appropriate one of cards 600_1 through 600_Z. Any response, such as read data for a read command is sent to the controller 611a for forwarding up to the system. Note that each of the memory devices of cards 600_1 through 600_Z have a memory device side instance of layer 404a and physical layer 504b to receive and understand (and respond to if necessary) commands sent by the controller 611a.

FIG. 6b shows another embodiment of multiple PCIe cards that are plugged into a computing system. Notably, card 650_1 is designed according to the design 520 of FIG. 5. The other cards 650_2 to 650_Z do not include a controller. Rather, the PCIe portion 504b of the card 650_1 having the controller 611b acts as a master hub or router of commands from the controller 611b to the other cards 650_2 to 650_Z. As cards 650_2 to 650_Z do not even have a controller, and instead receive upper layer 404a commands from the controller 611b of card 650_1, even additional power and surface area savings are realized.

The additional power and surface area savings permit the population of even more non volatile memory devices on cards 650_2 through 650_Z than on card 650_1 (specifically, R memory devices where R>M). Further still, the lack of a controller on cards 650_2 through 650_Z should cause them to exhibit even more reduced latency on a per transaction basis than card 650_1 (which as discussed above should itself have reduced latency compared to the prior art solution of inset 410). As such, a backplane 630b of a system having cards 650_1 through 650_Z plugged into it should exhibit noticeably greater storage density and smaller latencies than the same number of cards having fully implemented ONFI solutions.

With the controller 611b on card 650_1 acting as a routing hub for cards 650_2 through 650_Z, a PCMS/FLASH memory interface command sent by the system to a memory device on any of cards 650_2 through 650_Z is first sent to card 650_1. The controller 611b on card 650_1 then forwards the command (e.g., by adding new destination address information to the packet received from the system) to the appropriate one of cards 650_2 through 650_Z. As such, the command flows “off” card 650_1 to the appropriate one of cards 650_2 through 650_Z. Any response, such as read data for a read command is sent to card 650_1 for forwarding up to the system. Note that each of the memory devices of cards 650_2 through 650_Z have a memory device side instant of layer 404a and physical layer 504b to receive and understand (and respond to if necessary) commands sent be the controller 611b.

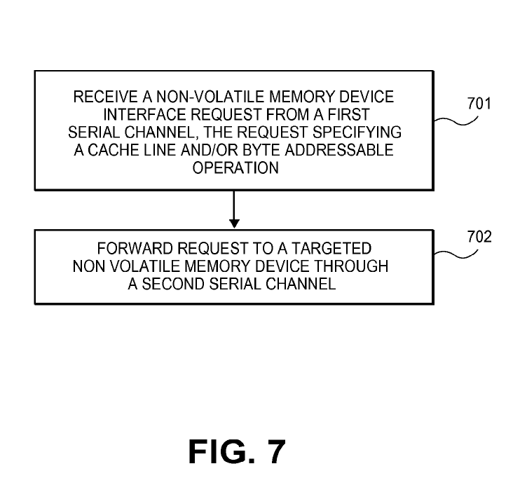

FIG. 7 shows a methodology that can be performed by the new device 500 of FIG. 5 or the controllers 611a,b of FIGS. 6a,b. According to the methodology of FIG. 7, a read or write request for a cache line or a byte addressable operation is received 701 from a system through a first serial channel (e.g., through a first PCIe connection). The received request is formatted according to a PCMS or FLASH memory device interface protocol and specifies a cache line an/or a byte addressable operation. The request is then forwarded 702 through a second serial channel (e.g., a second PCIe connection) to the appropriate PCMS or FLASH memory device. The command may be forwarded to a different card and/or device than the card and/or device that receives the request (e.g., if the card/device that receives the request is acting as a hub for other cards such as discussed above with respect to FIG. 6).

If the request is for a read, the targeted PCMS or FLASH memory device interprets the read command and performs the read. The read data is returned on the second serial channel in a format that is consistent with the underlying functions of the applicable PCMS or FLASH interface. The read data is then forwarded to the system over the first serial channel through the PCMS or FLASH interface. If the request is for a write, the targeted PCMS or FLASH device interprets the write command and performs the write.

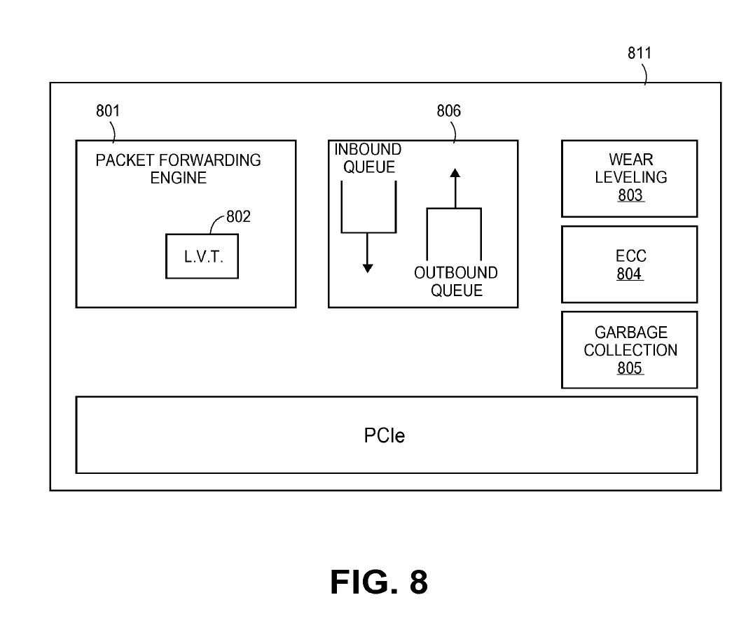

FIG. 8 shows a more detailed embodiment of the controller 511 of FIG. 5 or the controllers 6a,b of FIGS. 6a,b. As discussed above, the controller 811 may include a thin translation layer 801 that forwards packets received from a system side PCIe connection to a PCMS or FLASH memory device side PCIe connection. The forwarding may at least include using an address targeted by the system as a look-up parameter to identify a new destination address for the received packet. As such, the controller may include embedded memory or register space for keeping a look-up table 802 to perform the look-up.

The controller may also include logic circuitry to implement any of the following functions for the memory devices it oversees (both on card and off card): i) wear leveling 803; ii) ECC circuitry for error correction encoding/decoding/correction 804; iii) garbage collection 805 (which is an automated function for erasing removing stale information); iv) inbound and/or outbound queuing of commands and/or responses 806. Note that logic circuitry for any of functions 803, 804, 805 can also be implemented on the individual memory devices themselves in combination with or instead of these same functions being implemented on the controller 811. The controller may also include lightweight metadata management in case the system seeks to address the memory devices in a more abstract manner that does not explicitly or directly reference specific channel and die.

Additional extended functions are also possible. Examples include mirroring. This feature allows one card having non volatile memory devices to receive a write command, process the data to its local non volatile memory devices, while at the same time, forwarding the command to another card, which writes a mirror of the data to its local non volatile memory devices, thereby increasing the reliability of the stored data (if one copy fails, another copy is available to read).

1. A method, comprising:
receiving a command from a system, said command identifying a particular non volatile memory, said command delivered over a point to point link; and,
forwarding said command to said non volatile memory.

2. The method of claim 1 wherein said forwarding of said command includes directing said command over a second point-to-point link to said non volatile memory device.

3. The method of claim 2 wherein said second point-to-point link is a PCIe point-to-point link.

4. The method of claim 3 wherein said point-to-point link is a PCIe point-to-point link.

5. The method of claim 1 wherein said point-to-point link is a PCIe point-to-point link.

6. The method of claim 1 wherein said receiving and forwarding is performed by a controller that is supporting an ONFI interface, said command being an ONFI formatted command.

7. The method of claim 1 wherein said non volatile memory is a FLASH random access memory or PCM random access memory.

8. The method of claim 1 further comprising mirroring said command to another non volatile memory on a different card than a card upon which said non volatile memory is upon.

9. A method, comprising:
sending a command to a non volatile random access memory over a point-to-point link, said non volatile random access memory attached to an end of said point-to-point link.

10. The method of claim 9 wherein said point-to-point link is a PCIe point-to-point link.

11. The method of claim 9 wherein said point-to-point link runs through a backplane that connects a system to a card that is plugged into said backplane and that holds said non volatile random access memory.

12. The method of claim 9 wherein said point-to-point link is within a package having a controller and said non volatile memory device, wherein said controller performs said sending.

13. The method of claim 9 wherein said sending is performed by a controller that resides on a different card than said non volatile random access memory.

14. A semiconductor chip, comprising:
a controller having a point-to-point link interface and non volatile memory interfacing circuitry, said point-to-point link interface to receive a command from a system that identifies a particular non volatile memory, said non volatile memory interfacing circuitry to receive and forward said command to said non volatile random access memory.

15. The semiconductor chip of claim 14 wherein said semiconductor chip is integrated into a computing system.

16. The semiconductor chip of claim 15 wherein said semiconductor chip is integrated on a device that plugs into a backplane of said computing system.

17. The semiconductor chip of claim 16 wherein said non volatile memory interfacing circuitry is ONFI non volatile memory interfacing circuitry.

18. The semiconductor chip of claim 14 further comprising a second point-to-point link interface, said second point-to-point link interface to send said forwarded command to said non volatile random access memory.

19. The semiconductor chip of claim 15 wherein said controller and said non volatile random access memory are integrated into a same package that plugs into a backplane of said computing system.

20. A semiconductor chip, comprising:
non volatile random access memory storage cells; and,
a point to point link to receive read and write accesses directed to said storage cells.
